(19) United States
(12) Patent Application Publication
(10) Pub. No.: US 2006/0133099 A1
(43) Pub. Date: Jun. 22, 2006

(54) Egress lighting timer

(75) Inventors: James Thannikary, Aurora, IL (US); Mark S. Haan, Batavia, IL (US)

Correspondence Address: CNH AMERICA LLC, INTELLECTUAL PROPERTY LAW DEPARTMENT, PO BOX 1895, MS 641, NEW HOLLAND, PA, 17557, US

(73) Assignee: CNH America LLC

(21) Appl. No.: 11/018,178

(22) Filed: Dec. 21, 2004

(51) Int. Cl. B60Q 1/076

(52) U.S. Cl. 362/459

(57) ABSTRACT

An exit lighting system for a work vehicle includes an exit light, controller connected to the exit light, and an operator interface connected to the controller for selecting various modes of operation. The operator interface includes a display that shows several exit lighting settings and an operator input device that permits the operator to adjust the settings, such as by turning the exit lighting on and off, selecting the exit light duration, and checking a light sensor to be sure it is dark before using the exit lights. The exit lights turn on when one or more of several operator selectable conditions exist: the operator doors are opened or closed, the atmospheric lighting is low, the headlights are on (prior to ignition off), and the ignition switch is turned off.

### FIELD OF THE INVENTION

The invention relates generally to off-road vehicles, and more particularly to tractors or work vehicles that are operated in low ambient light.

### BACKGROUND OF THE INVENTION

Tractors and other off-road work vehicles typically operate outside, away from electric lighting such as street lights. Operators end the work day by parking, exiting and locking the work vehicle. They then walk to other on-road transportation such as their personal automobile, in order to leave the work site. Depending on the season of the year and the length of the work day, their departure from the parked work vehicle may occur in darkness.

The terrain at the work site may be quite rugged, and work materials such as metal and glass pieces may be strewn about the ground. The on-road transportation may be a long walk away from where the off-road work vehicle is parked. Walking in these circumstances can be difficult, with tripping hazards and the potential for the operator to become lost while trying to find his automobile.

Alternatively, if the tractor is parked in an enclosed but unlit structure, such as a barn or utility building, there will be a similar lack of surrounding lighting. With multiple vehicles and agricultural implements stored in the unlit structure, finding one's way out of the building is difficult without some source of lighting. A walk that might take a only minute or two with adequate lighting, may take substantially longer in darkness.

The prior art teaches an apparatus for turning on exit lights for a fixed length duration after a vehicle ignition switch is turned off, using an analog circuit with an associated time constant. The operator switches the ignition off, and the time delay lighting system engages, providing external light for a preset period of time established by the RC decay time of the analog circuit. The inputs are the ignition and in some cases the headlights and door switch. This method does not allow the operator to change the duration of the exit lighting.

The prior art also teaches a similar analog circuit with three preset delays, from which the operator may choose. This gives more flexibility, but does not allow the operator to freely change the exit lighting duration. To change the preset delays requires a hardware change in the electronic circuit that is not typically an operator function, and would require exiting the vehicle to gain access to the lighting circuit.

The prior art also teaches an exit lighting system with operator input device inside the cab of a work vehicle, which allows the operator to select a preset exit lighting duration. This method uses a controller of some type. However the duration is preset, and the controller does not give the operator complete control over the length of the exit light duration

The prior art also teaches a vehicle exit lighting system that includes an ambient light sensor to determine whether the surrounding light is low. The method also allows the operator to freely select the exact time duration of the exit lighting. However, the operator must engage a switch for an amount of time equal to the desired exit lighting. This is cumbersome and adds unnecessary delay when exiting the vehicle, particularly if the operator needs an extended period of time to exit. The operator would, for example, need to depress the exit light duration switch for ten minutes in order to set a ten minute exit lighting duration. Also, the system does not provide a graphical feedback indicator to the operator of what the exit light duration is. The operator may forget the current duration and feel the need to reset the duration unnecessarily.

What is needed is a rapid method of setting and remembering an exact exit lighting duration, without having to engage a switch for a prolonged period of time. What is also needed is a system that incorporates multiple inputs, including detection of ambient lighting, whether the ignition is on or has been switched off, whether the headlights are on or have been switched off, whether the cab door has been opened or closed, what exact time duration the operator has selected, and what automatic lighting controls the operator wishes to occur. What is further needed is comprehensive graphical feedback to the operator of his exit lighting option selections, including the duration he has selected. What is also needed is for the graphical interface, both operator input device and graphical display, to be located within reach of the operator inside the cab while operating the work vehicle. What is further needed is a selection of possible operator input devices, so the operator can choose which best suits his operational style and input methods.

### SUMMARY OF THE INVENTION

In accordance with a first aspect of the invention, an off-road vehicle lighting system is provided that includes at least one exit light, an electronic controller coupled to the at least one exit light to turn the at least one exit light on and off, and an operator input device coupled to the controller and disposed in an operator compartment, the device configured to select an exit light duration, wherein the controller is configured to set the exit light duration independent of an operator input device engagement time.

The operator input device may be an analog potentiometer, wherein the exit light duration is zero when the potentiometer is in a first position, and wherein the potentiometer has a range of positions, and the exit light duration is proportional to the potentiometer position. The electronic controller may include a digital microprocessor including a digital memory, and wherein the exit light duration is stored in the memory. The off-road vehicle lighting system may include a graphical display, coupled to and driven by the controller, wherein the graphical display is configured to numerically display the exit light duration.

In accordance with a second aspect of the invention, a vehicle exit lighting control system is provided that includes at least one exit light, an electronic controller coupled to the at least one exit light to turn the at least one exit light on and off, an operator input device coupled to the controller, the input device configured to select an exit light duration, and a graphical display coupled to the controller, the display configured to display the exit light duration.

The controller may include a microprocessor and a digital memory coupled to the microprocessor, wherein the microprocessor is configured to store the exit light duration in the memory. The graphic display may indicate the exit light duration numerically. The graphic display may indicate a current operator selected state of the at least one exit light. The controller may be configured to respond to a key switch input provided by an ignition key switch, the key switch input having an ON state when the ignition key switch is on, the key switch input have an OFF state when the ignition key switch is off. The exit light duration may be triggered when the key switch input changes from ON state to OFF state. The controller may be configured to respond to a cab door open switch input provided by a cab door switch, the cab door open switch input having an ON state when the cab door is open, the cab door open switch input having an OFF state when the cab door is closed. The exit light duration may be triggered when the key switch input is in OFF state and after the cab door open switch input changes from OFF state to ON state. The vehicle exit lighting control system may include a relay, the relay electrically coupled between the at least one exit light and the controller. The controller may be configured to respond to a night sensor input provided by a night sensor, the night sensor input having an ON state when the surrounding lighting is low, the night sensor input having an OFF state when the surrounding lighting is not low. The controller may be configured not to turn the at least one exit light on if the night sensor input is in OFF state. The controller may be configured to control the at least one exit light based upon a state of at least one driving light. The exit light duration may be triggered if the at least one driving light is on when an ignition switch of the vehicle is turned off.

In accordance with a third aspect of the invention, a method for configuring a vehicle exit lighting control system is provided, including the steps of: (a) displaying exit lighting options on a graphical interface, (b) selecting one of the exit lighting options on a graphical interface, and (c) storing the exit lighting options in nonvolatile digital memory.

One of the exit lighting options may disable exit lighting. One of the exit lighting options may turn on exit lights for a predetermined duration after a vehicle ignition is turned off. One of the exit lighting options may turn on exit lights for a variable duration after a vehicle ignition is turned off. The step of displaying exit lighting options may include displaying an ignition mode option. One of the exit lighting options may disable exit lights during the day time. One of the exit lighting options may enable exit lights during the day time. The step of displaying exit lighting options may include displaying a time-of-day option. The step of selecting one of the exit lighting options may include entering a time duration parameter, thereby delaying the extinguishing of exit lights for a time delay equal to the time duration parameter after ignition is turned off. The step of selecting one of the exit lighting options may include pressing a touch-screen panel of the graphical interface. The step of selecting one of the exit lighting options may include pressing navigation buttons of the graphical interface. The step of selecting one of the exit lighting options may include pressing a numeric keypad of the graphical interface.

In accordance with a fourth aspect of the invention, a vehicle exit lighting control system is provided, including light means for lighting an exit, control means coupled to the light means for turning the light means on and off, input means coupled to the control means, for selecting a duration the light means is turned on, and display means coupled to the control means, for displaying the duration.

The display means may be configured to display the duration numerically. The vehicle exit lighting control system may include night sensing means coupled to the control means, for determining whether the surrounding light is low. The vehicle exit lighting control system may include memory means coupled to the control means, for storing the duration.

### BRIEF DESCRIPTION OF THE DRAWINGS

FIG. 1 is a schematic diagram of an exit lighting system in accordance with the present invention.

FIG. 2 is a first graphical display menu of exit lighting options corresponding to the ignition mode.

FIG. 3 is a second graphical display menu of exit lighting options corresponding to the time-of-day mode.

FIG. 4 is a third graphical display menu of exit lighting options corresponding to the operator entry of time duration.

### DETAILED DESCRIPTION OF THE PREFERRED EMBODIMENTS

An “exit light” refers to one or more lights on a vehicle that are configured to give the vehicle operator clear view of the surrounding area when exiting a vehicle in darkness. An “exit light sequence” refers to turning exit lights on, waiting for a period of time, and then turning them off. An “exit lighting system” refers to a control system on a vehicle that monitors vehicle and operator inputs, and uses them to determine when to execute (or trigger) the exit light sequence and for how long a period of time, and executes the exit light sequence.

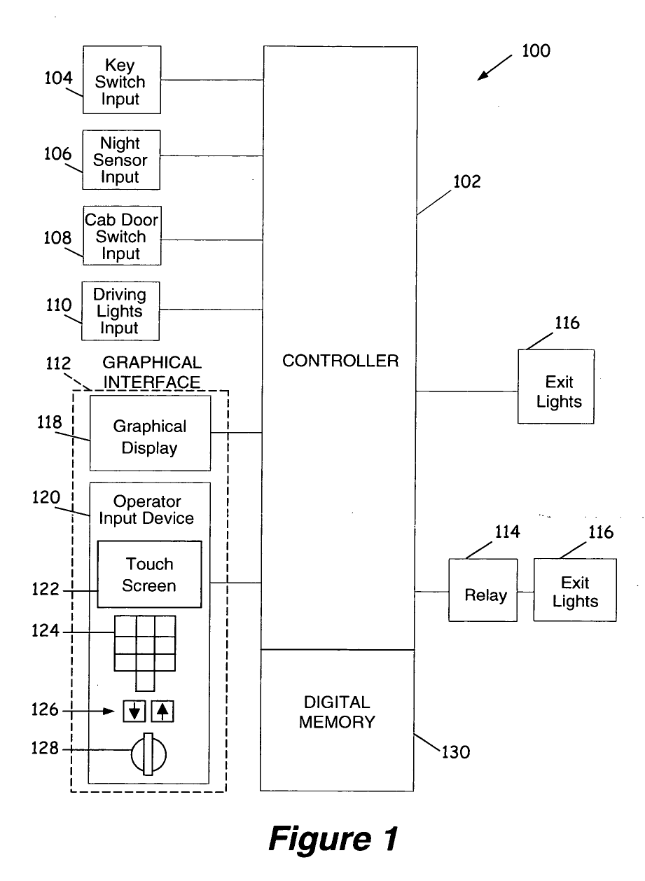

FIG. 1 shows an exit lighting system 100 for a work vehicle. The central element in the exit lighting system is the controller 102. Electronically coupled to the controller are the key switch input 104, night sensor input 106, cab door switch input 108 and driving lights input 110, graphical interface 112, relay 114 and exit lights 116. The graphical interface 112 includes the graphical display 118 and operator input device 120. The operator input device includes, either together or alternatively, the touch screen 122, numeric keypad 124, navigation buttons 126 and potentiometer 128. The controller includes memory 130.

The operator uses the graphical interface 112 to instruct the controller 102 how he wishes the exit lights 116 to function. The controller 102 uses the inputs 104, 106, 108, 110, graphical interface 112, and memory 130 to control the state of the exit lights 116. Elements of the exit lighting system 100 may be located anywhere in or on the work vehicle. The graphical interface is preferably located in the operator cab of the work vehicle, within easy reach of the operator while driving or otherwise operating the vehicle.

The controller 102 is an electronic control unit (ECU), preferably including a digital microprocessor, and is communicatively coupled with digital memory 130. The memory is preferably a commercially available non-volatile random access memory. There may be multiple controllers 102 connected with a communication bus such as CANBUS or Ethernet.

Inputs 104, 106, 108, 110 represent electronic signals coming into the controller 102, and signal the state of their respective devices, an ignition or key switch, a night sensor, a cab door switch and driving lights. The devices need not be directly connected to the controller. The key switch input 104 communicates a signal to the controller which represents the state of the ignition key switch. If the operator has turned the ignition key to the ON position, the key switch input 104 will communicate the ON state to the controller 102. This ON signal may be communicated to controller 102 digitally or as an analog voltage level of either high or low. Similarly, if the operator turns the ignition key to the OFF position, the key switch input communicates this OFF state to the controller. The controller 102 monitors the state of all input signals in order to detect a change in state.

Similarly to input 104, inputs 106, 108, 110 communicate ON or OFF signals to the controller 102 that represent ON or OFF states of the devices that provide the signals. The night sensor input 106 is communicatively coupled to a surrounding light sensor. The sensor detects low ambient light, i.e. darkness or night time, outside the work vehicle. If the night sensor detects darkness the night sensor input communicates an ON signal to the controller 102, otherwise the night sensor input communicates an OFF signal to controller 102 to signify day time.

The cab door switch input 108 is communicatively coupled to a door switch that detects whether the operator cab door is open or closed. If the cab door switch detects that the cab door is open, the cab door switch input communicates an ON signal to the controller 102, otherwise the cab door sensor input communicates an OFF signal signifying the cab door is closed. The cab door switch may be mechanical push button, inductive proximity, photo-electronic or any other durable and inexpensive type of two-position switch.

The driving lights input 110 is typically communicatively coupled to the vehicle's headlight circuit, and detects whether the operator has turned the driving lights on or off. The driving lights input is another, indirect way of determining the ambient light level, in that the operator would not have the headlights turned on unless the surrounding light was insufficient for normal operations. If the headlights are on, then the work vehicle is probably operating in darkness. The driving lights input 110 may be used instead of the night sensor input 106, to determine the surrounding light level indirectly.

The graphical interface 112 includes a graphical display 118 and operator input device 120. The graphical interface 112 provides one output, the graphical display 118, and multiple alternative inputs included in the operator input device 120. Controller 102 is coupled to graphical display 118 to drive the display and generate a sequence of menus. Controller 102 is coupled to operator input device 120 to receive operator commands indicating the desired exit lighting options to select and menus to display. Typically, all elements of the graphical interface are located near each other, on either the wall of the operator cab or on a console. This allows the operator to control all functions of the exit lighting system with a minimum of movement, while seeing the results of system changes immediately on the graphical display118.

The graphical display 118 is a liquid crystal display (LCD) panel, but may alternatively be a cathode ray tube (CRT) display monitor, electro luminescent panel or simply graphic indicators printed on the operator console. The graphical display is configured to present the currently available options to the operator, and communicates the current state of the exit lighting system to the operator. At a minimum, the graphical display will show the numerical value of the current exit light duration. The display may also show the exit light duration graphically, for example as a bar of varying size, or as a light bulb or other symbol with a varying shade of gray proportional to the exit time duration. The graphical display shows the current state of the exit lights (ON or OFF) either alphanumerically or graphically.

Exit lighting options are provided by a series of egress lighting adjust menus displayed on the LCD panel, as part of a morecomplex work vehicle control system of dozens of menus. The menus are sent to the graphical display 118 by the controller 102.

The operator input device 120 includes at least one of its alternative operator input elements 122, 124, 126, 128. These elements send signals to the controller 102 when the operator manipulates them. Typically, the operator input device will comprise multiple navigation buttons 126. By pressing the appropriate navigation buttons, the operator navigates between work vehicle control system menus on the graphical display 118. The operator also uses the navigation buttons 126 to select exit lighting options, and enter values such as the exit light time duration. One navigation button may signify increasing a value, and another button may decrease a value. Yet another button may store the information in digital memory 130, etc. The buttons and other operator input devices may vary depending on the complexity of the work vehicle control system, and whether the control system is part of original equipment or an after-market field installation. The navigation buttons are of the momentary-contact type and usually push buttons or membrane pad switches.

Instead of navigation buttons, operator input device 120 may use touch screen 122 to enter information and change screens. The touch screen is transparent and usually integral to the graphical display 118, and overlaid on top of the graphical display. However, the touch screen 122 may be separate and laminated to the graphic display 118. To use the touch screen, the operator interprets the visual elements on the graphic display through the touch screen, gently pressing the touch screen directly on top of the visual element to select that element.

Operator input device 120 may alternatively use a numeric keypad 124 located near the graphic display to enter values such as the exit light duration, i.e. the number of seconds that the exit lights will remain on after he switches the work vehicle ignition off. The numeric keypad is physically and electronically similar to the navigation buttons 126, being momentary and of either the push button or membrane pad type.

The potentiometer 128 is the recommended retrofit of the exit lighting system to an existing work vehicle that has no touch screen 122, numeric keypad 124 or navigation buttons 126. Potentiometer 128 can be used with graphical display 118 to set the time interval. The potentiometer is of the analog rotating switch variety. When rotated all the way in one direction, the potentiometer enters an OFF zone of rotation that generates a low voltage signal to the controller representing an OFF state for the exit lighting system. In this case, the controller will not turn on the exit lights when the operator switches off the ignition. When rotated out of the OFF zone of rotation, the potentiometer presents a varying voltage signal to the controller 102 proportional to the amount of rotation of the potentiometer. The controller interprets this variable voltage signal and assigns a corresponding exit light time duration, up to a predetermined maximum duration that corresponds to the analog potentiometer 128 being fully rotated away from the OFF position. The graphical display 118, in this case, would typically consist of printed labels on the operator console adjacent to the potentiometer, showing the OFF position, gradient marks showing amounts of intermediate time duration and the maximum time duration.

The exit lights are typically a combination of internal (i.e. inside the operator cabin) and external (i.e. outside the operator cabin) lights of the work vehicle. The exit lights 116 are commercially available and may include any combination of the driving lights (headlights), brake lights, work area side flood lights, outside exit area lights, operator cab dome lights, cab floor lights or other vehicle lights. The controller 102 sends either a high or low voltage output signal to the exit lights 116, causing them to turn on or off. Alternatively, one or more commercially available electronic relays 114 may be interposed electronically between the controller 102 and one or more of the exit lights 116. In this configuration, controller 102 drives relays 114, causing them to connect the exit lights 116 to a source of power, such as the vehicle battery.

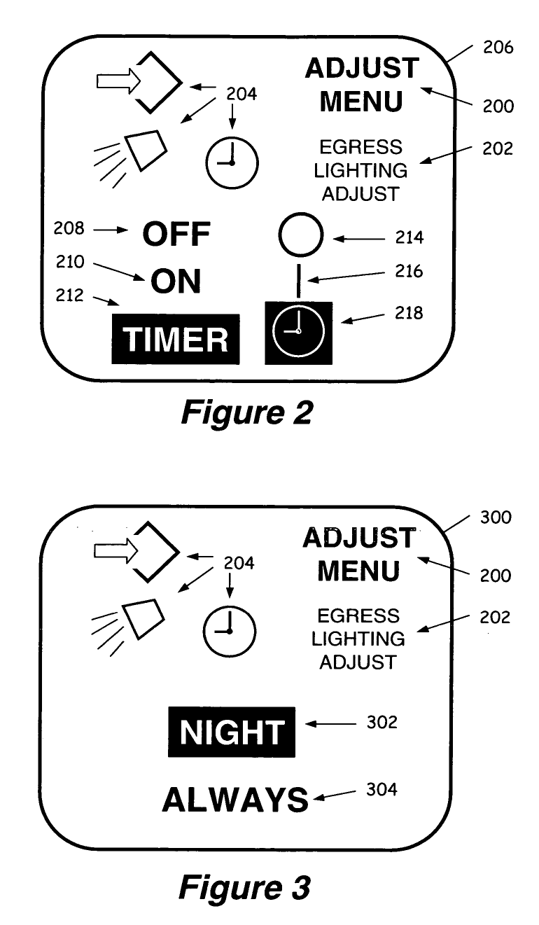

The controller 102 is configured to display the graphical control menus shown in FIGS. 2, 3 & 4. The operator uses the operator input device 120 while viewing the menus on graphical display 118 to control the exit lighting system. The controller 102 is configured to arrange the menus in a hierarchy, grouped by function. The controller is configured to display the main menu group name 200 and the menu subgroup name 202, which together designate the location of each menu in the control menu hierarchy. In FIGS. 2, 3 & 4, the controller 102 displays all the exit lighting system menus with a subgroup name 202 of “EGRESS LIGHTING ADJUST” and a main menu group name 200 of “ADJUST MENU”. Additionally, the controller 102 is configured to display a unique menu name, if a unique name exists. The controller is configured to display supplementary menu symbols 204 that further illustrate the function of each menu group.

The operator uses the operator input device 120 to request a menu be displayed. The controller 102 is configured to monitor and respond to the operator input device request, and display the selected menu on the graphical display 118. The operator then uses the operator input device 120 to change exit lighting options, including setting the exit light duration. The controller 102 responds to the operator input device 120 by changing the option (or value), storing it in memory 130, and displaying the changed option (or value) on the graphic display 118.

FIG. 2 is an ignition mode menu 206 that allows the operator to select the overall functioning of the exit lighting system 100. This menu includes three ignition mode options that the operator can select using operator input device 120: OFF 208, ON 210 or TIMER 212. There are also associated graphical symbols 214, 216 & 218 for each ignition mode, respectively. The TIMER ignition mode option 212 is currently selected, and it is seen, along with its associated TIMER ignition mode symbol 218 in reverse video. The menu uses reverse video (white text/graphic on a black background) rather than normal video (black text/graphic on a white background) to show a current selection. Reverse video is one method of specifying the current state of an exit light option, but other methods may be used, such as displaying a check mark on menu 206 next to the current option. This use of reverse video to display a current selection is also seen in FIGS. 3 & 4.

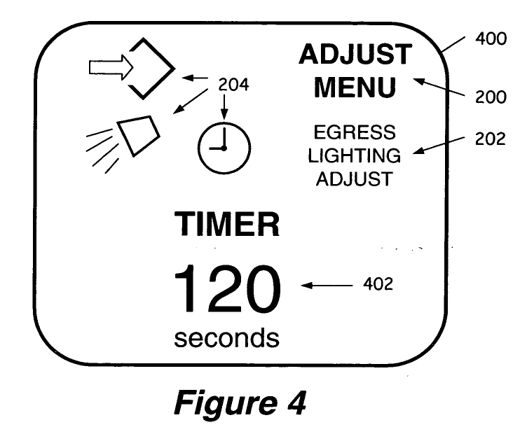

If the operator does not need any exit lights, whether in day or night operation, he selects the OFF ignition mode option 208. In response to receiving this signal from operator input device 120, the controller 102 is configured to ignore the current exit light duration 402 (shown in FIG. 4), and to disable exit lights 116. When the ignition is switched off, i.e. when the key switch input 104 signals an OFF state to the controller 102, controller 102 will not turn on the exit lights.

If the operator wants the exit lights to come on for a preset period of time upon exit from the work vehicle, he will select the ON ignition mode option 210. (A “preset period of time” refers to a duration of time that is unchangeable by the operator. This preset period may be determined by either a time constant in an analog timer circuit, or a constant value stored in the controller memory. The preset period is preferably 90 seconds.) The controller 102 will ignore the current exit light duration 402 (shown in FIG. 4), and instead will enable exit lights 116 when the ignition is switched off. The controller 102 will disable the exit lights 116 after the preset period of time has elapsed.

If the operator wants the exit lights to come on for an operator-entered period of time upon exit from the work vehicle, he will select the TIMER ignition mode option 212. In this mode, controller 102 waits for the ignition to be turned off, and then fetches the current exit light duration 402 (shown in FIG. 4) from memory 130 and starts a timer. The controller 102 then enables (i.e. turns on) the exit lights 116 and decrements the timer until the exit light duration 402 has elapsed. The controller 102 will then disable the exit lights 116. Controller 102 may provide the timer function in any of several ways common in the art, such as incrementing or decrementing a memory variable, using a separate timer circuit or dedicated application-specific integrated circuit chip, or using an entirely separate central processing unit or computer. If the operator does not choose to change the current exit light duration 402, he may then exit the menu and resume operating the work vehicle. Otherwise the operator may proceed to one of the other EGRESS LIGHTING ADJUST menus.

FIG. 3 is a time-of-day mode menu 300 that allows the operator to select whether the exit lighting system 100 is responsive to the surrounding light level, i.e. day time or night time. On this menu, there are two time-of-day mode options from which to select: NIGHT 302 or ALWAYS 304. The NIGHT time-of-day mode option 302 is currently selected, and is seen in reverse video.

If the operator only needs exit lights when the surrounding lighting is low, i.e. during the nighttime or in the shade or in the interior of a dark building, he selects the NIGHT time-of-day mode option 302. When the NIGHT option is selected and the ignition is turned off (key switch input 104 changes to the OFF state) the night sensor input 106 must also be ON (signifying a low light situation) or the tractor lights must be ON during or prior to key off (as indicated by the driving lights input 110) before the controller 102 will initiate the exit light sequence. The operator will normally leave the exit lighting system 100 operating in NIGHT time-of-day mode.

If the operator wants the exit lights to function regardless of the surrounding light level, he selects the ALWAYS time-of-day mode option 304. When the ALWAYS option is selected and the ignition is turned off, the controller 102 initiates the exit light sequence regardless of the night sensor input 106. The operator may choose the ALWAYS option if the night sensor location on the vehicle is in sunlight, while the cab door and exit area of the work vehicle are in shadow. The operator might also choose the ALWAYS option if the night sensor is faulty or misadjusted and has not yet been repaired. The operator may exit this menu and resume operating the work vehicle, or proceed to another graphical control menu.

Referring to FIG. 4, the exit light duration menu 400 allows the operator to select or enter the time period (in seconds) that the exit lighting system 100 will light the exit lights while he exits the vehicle before automatically turning them off. This is called the “exit light duration”. On this menu, the current exit light duration 402 is shown to be 120 seconds. The operator uses one of the alternative operator input devices, either the touch screen, numeric keypad, navigation buttons or potentiometer, to change the value of the exit light duration. As the changes are made, the new exit light duration is shown on the graphical display 118 so the operator has immediate feedback that the change has occurred.

Setting the exit light duration is a very quick process. In the prior art the operator had to interact with or engage an operator input device (i.e. hold it in position, or otherwise tend it) for a period of time equal in length to the exit light duration the operator wished to set. Thus, for example, if the operator wished to set a 10 minute exit duration time, the operator would have to remain at the vehicle for the entire 10 minutes just to set it. The process of setting the exit light duration was at least as long as the exit light duration itself. The time required for the operator to set the exit duration time is called the “operator input device engagement time” herein.

Unlike the prior art, the operator can set the exit duration time rapidly, and does not need to stay at the vehicle for an entire exit duration time just to set a new exit duration time.

The operator may quickly use the numeric keypad 124 to set the exit light duration by pressing two or three digits (in the illustrated example, this would be digits [1], [2] and [0] for the 120 second exit duration time). This takes less than a second, much less than the 120 second exit duration time.

The operator may alternatively use the navigation buttons 126 to increment or decrement the exit light duration, by pressing the corresponding increase (the up arrow) or decrease (the down arrow) buttons. With each press, controller 102 is configured to increment the time delay by a predetermined amount, which is preferably configured in controller 102 to be between one second and 30 seconds. To set a 120 second exit duration time, for example, the operator simply presses one of the navigation buttons a few times. Each time the operator presses a button, controller 102 commands the graphical display to either increment (if the up arrow is pressed) or decrement (if the down arrow is pressed) the time interval displayed on the graphical display. If controller 102 is configured to increment or decrement the exit duration time in steps of 10 seconds, for example, 12 quick presses, taking perhaps five seconds total is all the time required to select a 120 second time interval. Five seconds is considerably less than the 120 seconds it would have taken using the prior art.

Alternatively, if the operator input device is potentiometer 128, the operator may simply rotate the potentiometer 128 to the desired time value. This process is quick since, as explained above, the alternative graphic display may be indicia printed around the periphery of the potentiometer indicating which position corresponds to a specific exit duration time. The time necessary to rotate the potentiometer to any position in its range of positions is a fraction of a second, far less than the 120 second exit duration time. Thus, the operator can set a 120 second time interval in much less time than 120 seconds.

Whichever method the operator chooses to set the exit light duration, the controller 102 monitors the operator input device 120, changes the value, and displays the new value on the graphical display 118 immediately.

Using the exit light duration menu gives the operator quick, complete and accurate control over the length of time he wishes to exit the vehicle with adequate lighting. If his personal transportation is parked farther away from the work vehicle, necessitating a longer exit time to negotiate rough terrain and obstacles in darkness, he will enter a longer exit light duration 402, such as 600 seconds (10 minutes). Otherwise, a shorter exit light duration, such as 60 seconds (1 minute) may be appropriate. The operator is in full control at all times, without having to exit the cab to make adjustments, or waste valuable working time by holding down a switch or otherwise tend an electronic controller for a long time as per the prior art.

The controller 102 acts upon and logically combines in different ways the set of inputs 104, 106, 108, 110, 120 to initiate the exit light sequence, depending on the programming or wiring of the controller. In one embodiment, the controller 102 is configured to trigger the exit light sequence when the ignition is turned off (key switch input 104 changes from ON to OFF state), and the OFF ignition mode has not been selected, and the ALWAYS time-of-day mode option has been selected. In another embodiment, the controller 102 is configured to trigger the exit light sequence when the ignition is turned off (key switch input 104 is in the OFF state) and the cab door has been opened (cab door switch input 108 changes from OFF state to ON state), i.e. when the operator is exiting the cab. In a further embodiment the controller 102 is configured to use the headlights as a determinant of night time rather than the night sensor. In this case, the controller is configured to trigger the exit light sequence when the ignition is turned off (key switch input 104 changes from ON to OFF state), while the headlights are on (driving lights input 110 is in the ON state), i.e. when the operator was using the headlights at the time the work vehicle's engine was stopped (night time operation).

There are alternative approaches to the preferred embodiments. The controller may trigger the exit light sequence when a motion sensor within the cab signals there has been no movement for a period of time after the ignition has turned off, signifying that the operator has left the cab. The operator may change the exit light duration by pressing the touch screen at the location of a non-numeric graphical symbol, such as a bar, that represents the exit light duration—thereby incrementing or decrementing the value.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

We claim:

1. An off-road vehicle lighting system comprising:
at least one exit light;
an electronic controller coupled to the at least one exit light to turn the at least one exit light on and off; and
an operator input device coupled to the controller and disposed in an operator compartment, the device configured to select an exit light duration;
wherein the controller is configured to set the exit light duration independent of an operator input device engagement time.

2. The off-road vehicle lighting system of claim 1, wherein the operator input device is one of an analog potentiometer, a touch screen, a set of navigation buttons, and a numeric keypad;
wherein the exit light duration is zero when the potentiometer is in a first position; and
wherein the potentiometer has a range of positions, and the exit light duration is proportional to the potentiometer position.

3. The off-road vehicle lighting system of claim 1, wherein the electronic controller comprises;
a digital microprocessor including a digital memory; and
wherein the exit light duration is stored in the memory.

4. The off-road vehicle lighting system of claim 1, further comprising:
a graphical display, coupled to and driven by the controller;
wherein the graphical display is configured to numerically display the exit light duration.

5. A vehicle exit lighting control system comprising:
at least one exit light;
an electronic controller coupled to the at least one exit light to turn the at least one exit light on and off;
an operator input device coupled to the controller, the input device configured to select an exit light duration; and
a graphical display coupled to the controller, the display configured to display the exit light duration.

6. The vehicle exit lighting control system of claim 5, wherein the controller comprises:
a microprocessor and a digital memory coupled to the microprocessor;
wherein the microprocessor is configured to store the exit light duration in the memory.

7. The vehicle exit lighting control system of claim 5, wherein the graphic display indicates the exit light duration numerically.

8. The vehicle exit lighting control system of claim 5, wherein the graphic display indicates a current operator selected state of the at least one exit light.

9. The vehicle exit lighting control system of claim 5, wherein the controller is configured to respond to a key switch input provided by an ignition key switch, the key switch input having an ON state when the ignition key switch is on, the key switch input have an OFF state when the ignition key switch is off.

10. The vehicle exit lighting control system of claim 9, wherein the exit light duration is triggered when the key switch input changes from ON state to OFF state.

11. The vehicle exit lighting control system of claim 9, wherein the controller is configured to respond to a cab door open switch input provided by a cab door switch, the cab door open switch input having an ON state when the cab door is open, the cab door open switch input having an OFF state when the cab door is closed.

12. The vehicle exit lighting control system of claim 11, wherein the exit light duration is triggered when the key switch input is in OFF state and after the cab door open switch input changes from OFF state to ON state.

13. The vehicle exit lighting control system of claim 5, further comprising:
a relay, the relay electrically coupled between the at least one exit light and the controller.

14. The vehicle exit lighting control system of claim 5, wherein the controller is configured to respond to a night sensor input provided by a night sensor, the night sensor input having an ON state when the surrounding lighting is low, the night sensor input having an OFF state when the surrounding lighting is not low.

15. The vehicle exit lighting control system of claim 14, wherein the controller is configured. not to turn the at least one exit light on if the night sensor input is in. OFF state.

16. The vehicle exit lighting control system of claim 5, wherein the controller is configured to control the at least one exit light based upon a state of at least one driving light.

17. The vehicle exit lighting control system of claim 16, wherein the exit light duration is triggered if the at least one driving light is on when an ignition switch of the vehicle is turned off.

18. A method for configuring a vehicle exit lighting control system, comprising the steps of:
(a) displaying exit lighting options on a graphical interface
(b) selecting one of the exit lighting options on a graphical interface
(c) storing the exit lighting options in nonvolatile digital memory.

19. The method of claim 18, wherein one of the exit lighting options disables exit lighting.

20. The method of claim 18, wherein one of the exit lighting options turns on exit lights for a predetermined duration after a vehicle ignition is turned off.

21. The method of claim 18, wherein one of the exit lighting options turns on exit lights for a variable duration after a vehicle ignition is turned off.

22. The method of claim 18, wherein the step of displaying exit lighting options includes displaying an ignition mode option.

23. The method of claim 18, wherein one of the exit lighting options disables exit lights during the day time.

24. The method of claim 18, wherein one of the exit lighting options enables exit lights during the day time.

25. The method of claim 18, wherein the step of displaying exit lighting options includes displaying a time-of-day option.

26. The method of claim 18, wherein the step of selecting one of the exit lighting options includes entering a time duration parameter, thereby delaying the extinguishing of exit lights for a time delay equal to the time duration parameter after ignition is turned off.

27. The method of claim 18, wherein the step of selecting one of the exit lighting options includes pressing a touch-screen panel of the graphical interface.

28. The method of claim 18, wherein the step of selecting one of the exit lighting options includes pressing navigation buttons of the graphical interface.

29. The method of claim 18, wherein the step of selecting one of the exit lighting options includes pressing a numeric keypad of the graphical interface.

30. A vehicle exit lighting control system comprising:
light means for lighting an exit;
control means coupled to the light means for turning the light means on and off;
input means coupled to the control means, for selecting a duration the light means is turned on; and
display means coupled to the control means, for displaying the duration.

31. The vehicle exit lighting control system of claim 30, wherein the display means is configured to display the duration numerically.

32. The vehicle exit lighting control system of claim 30, further comprising:
night sensing means coupled to the control means, for determining whether the surrounding light is low.

33. The vehicle exit lighting control system of claim 30, further comprising:
memory means coupled to the control means, for storing the duration.
